(19) United States
(12) Patent Application Publication
(10) Pub. No.: US 2004/0032807 A1
(43) Pub. Date: Feb. 19, 2004

(54) Hall element, motor assembly and optical disk device

(75) Inventor: Takakatsu Moriai, Honjo-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/638,301

(22) Filed: Aug. 12, 2003

(30) Foreign Application Priority Data
Aug. 14, 2002 (JP) 2002-236617

(51) Int. Cl. G11B 7/00

(52) U.S. Cl. 369/53.28

(57) ABSTRACT

Two magnetically sensitive poles are disposed on one chip with theoretically required dimensional accuracy. Therefore, the two magnetically sensitive poles can be disposed on a motor with high positional accuracy. Moreover, the simultaneous formation of the two magnetically sensitive poles in the same chip enables accurate matching of sensitivities between both magnetically sensitive poles when a magnetically sensitive film is printed on the chip.

### CROSS-REFERENCE TO RELATED APPLICATIONS

This application is based upon and claims the benefit of priority from the prior Japanese Patent Application No. 2002-236617, filed Aug. 14, 2002, the entire contents of which are incorporated herein by reference.

### BACKGROUND OF THE INVENTION

1. Field of the Invention

The present invention relates to a Hall element for sensing rotation of a motor, and an optical disk device which comprises an optical pickup feeder using the Hall element.

2. Description of the Related Art

As a pickup feeding method of an optical disk drive, there have heretofore been available a method which uses a stepping motor or the like to forcibly feed a certain amount of an optical pickup based on a predetermined pulse signals, a method which uses an optical encoder comprising two pairs of light emitting and receiving elements to feed an optical pickup while calculating a moving direction and a moving distance based on an electric signal generated by each light receiving element, a method which feeds an optical pickup while counting the number of ripple waves of an electric signal (RF signal) generated by the optical pickup to calculate a moving distance when the optical pickup is moved in a tracking direction, etc.

Miniaturization of electronic equipment such as personal computers in which optical disk drives are mounted has brought about a demand for miniaturization and thickness reduction of optical disk drives. Therefore, there has been recently employed a method which feeds a pickup by using two Hall elements enabling realization of miniaturization and low cost to calculate a moving direction and a moving distance of the pickup. In such a case, for example, a 10-pole magnetization magnet is attached to a motor to fix the two Hall elements to the motor side. A change in a magnetic field accompanied by rotation of the magnet is sensed by the two Hall elements, and an electric signal corresponding to the magnetic field change is output. A servo system circuit of an optical disk device controls the rotation of the feed motor, i.e., the moving amount of the optical pickup based on a Hall element output signal.

To generate a correct control voltage, the servo system circuit must satisfy the following basic conditions:

1) Output signal levels of both Hall elements are equal;

2) An angle between straight lines connecting centers of both Hall elements to a center of a rotary shaft equivalents to an electric phase difference of 90°; and

3) Magnetization pitches of the magnet are uniform.

However, to achieve the three basic conditions, the following problems must be solved respectively.

1) Output Signal Levels of Both Hall Elements are Equal

Due to the use of the two separate Hall elements, there is variance in electric performance, which makes it difficult to obtain similar output voltages. Therefore, there is a problem that an element maker must carry out sensitivity selection of several ranks and internal resistance selection, and execute paring by reels of the same rank.

2) An Angle Between Straight Lines Connecting Centers of Both Hall Elements to a Center of a Rotary Shaft Equivalents to an Electric Phase Difference of 90°

If the number of magnetization poles of the magnet is 10, an electric phase difference of 180° is set between adjacent N and S poles. When this is replaced by a mechanical angle, the angle becomes 360÷10=36°. As a phase difference of 90° is required between the Hall elements, the mechanical angle of each of the Hall elements with respect to the center of the rotary shaft becomes further half of 36°, i.e., 18°. However, since mounting of the two Hall elements on, for example, a circumference of radius 2 mm each at an angle 18° with respect to the center of the rotary shaft is impossible because of collision between Hall element chips, the two Hall elements are actually arranged at N times ±90° of the electric angle 180°.

Assuming that mechanical angle variance is 1° at the time of mounting, deviation from an electric angle 90° becomes 90°×1/18=5°. It is sheer deviation of 5.6%. If the two Hall elements are mounted on the circumference of radius 2 mm, the circumferential distance of the mechanical angle 18° equivalent to the electric angle 90° becomes 2×3.14×2×18÷360=0.628 mm. If this distance is deviated by 0.1 mm, deviation of the electric angle seems to be about 14° (16%). Apparently, the requirement of mechanical strength is very strict.

3) Magnetization Pitches of the Magnet are Uniform

As it is carried out by a magnetizer, magnetization is decided by initial fixture manufacturing accuracy. While variance due to external factors is limited, control is necessary at a component level.

Among the above problems, 1) level variance and 2) attaching accuracy are particularly difficult to control.

### BRIEF SUMMARY OF THE INVENTION

According to the present invention, two magnetically sensitive poles are disposed on one chip with theoretically required dimensional accuracy. Therefore, a Hall element can be attached to a motor with high positional accuracy. Moreover, the simultaneous formation of the two magnetically sensitive poles in the same chip facilitates control when a magnetically sensitive film is printed on the chip, and enables accurate matching of sensitivities between the two poles.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIGS. 1A and 1B are views showing a structure of a pickup feeder which comprises a Hall element of the present invention.

FIG. 2 is a detailed view of a Hall FPC.

FIGS. 3A and 3B are views showing a Hall element according to an embodiment of the present invention.

FIG. 4 is a view showing a B portion of the Hall FPC attached to a feed motor mount plate.

FIG. 5 is a block diagram showing a constitution of an optical disk device according to an embodiment.

FIG. 6 is a view showing a thread motor, a Hall element, a magnet and a processing circuit for processing an output signal of the Hall element.

FIG. 7 is a view showing waveforms of the Hall element output signal, a signal 01S—on which a saw-tooth wave is superimposed, and a signal output from a comparator 17.

FIG. 8 is a view showing a relation between the magnet and the Hall element.

FIGS. 9A to 9C are views showing various forms of Hall elements of the present invention.

FIGS. 10A to 10E are views showing an embodiment of a Hall element where an opening is provided for a chip.

### DETAILED DESCRIPTION OF THE INVENTION

The embodiments of the present invention will be described in detail with reference to the accompanying drawings. The embodiments of the invention described below are not limitative of a device and a method of the invention.

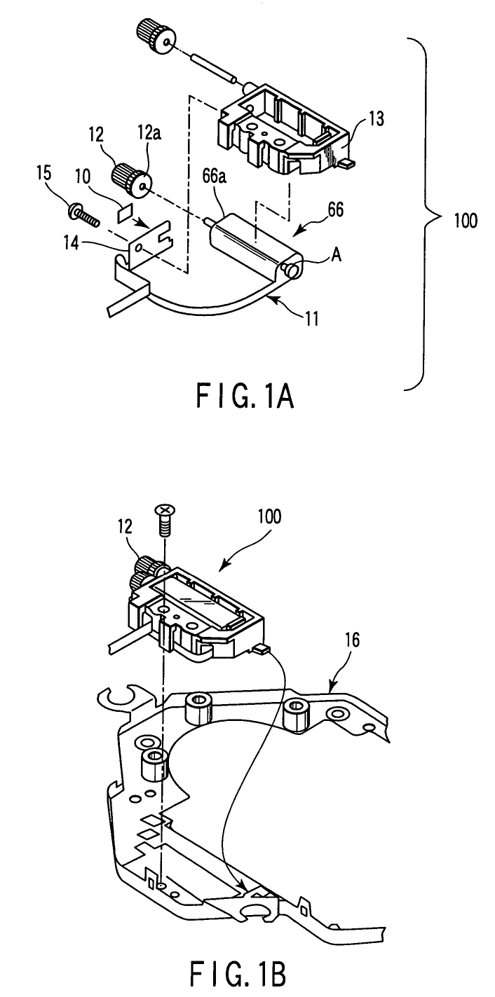

For an optical disk drive for a notebook PC, a constitution of various structures in a product having a thickness of 12.7 mm requires miniaturization of each component. FIGS. 1A and 1B show a structure where a Hall element 10 of the present invention for detecting a rotational direction and a rotational angle of a motor (thread motor) is used for a pickup feeder which moves an optical pickup in a disk radial direction. As shown in FIG. 1A, after a metal SUS plate 14 and the Hall element 10 are attached to a Hall flexible printed circuit (FPC) 11 having flexibility, the Hall FPC is attached to a motor 66. Further, a gear 12 or the like equipped with a magnet 12a is fixed to the motor 66, and the motor is fixed to a feed motor mount plate 13. At this time, the Hall element 10 is positioned between the magnet 12a and an end surface 66a of the motor 66. Then, as shown in FIG. 1B, an assembled motor assembly (pickup feeder) 100 is attached to a main chassis 16.

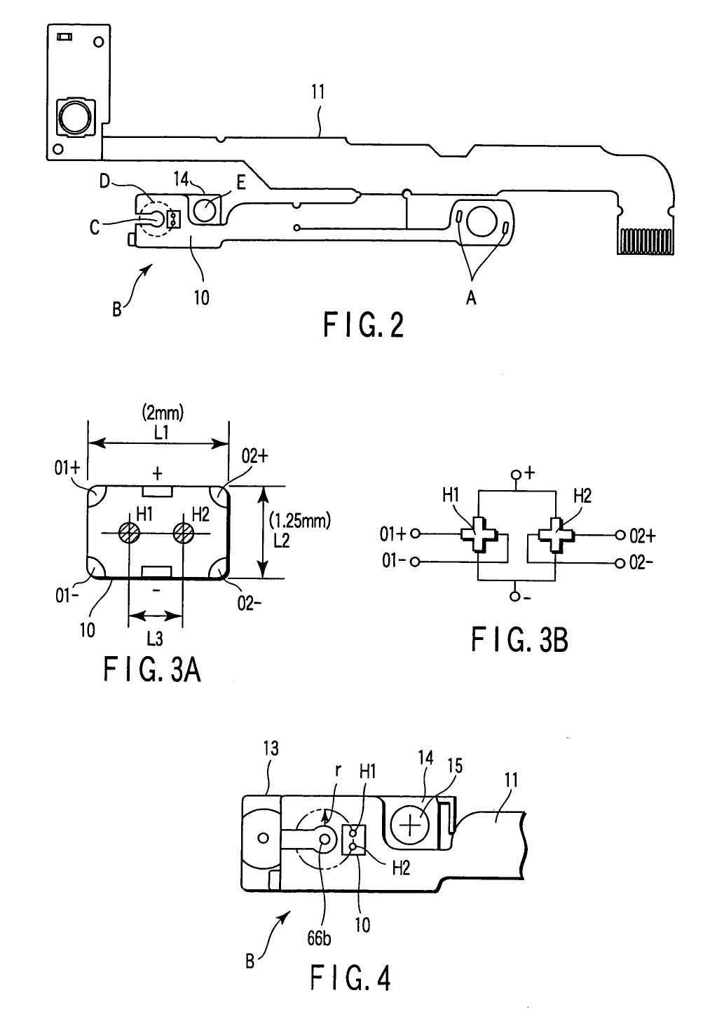

FIG. 2 is a detailed view of the Hall FPC. An A portion is soldered to a terminal of the motor 66, and a left Hall element portion B is fixed integrally with the SUS plate 14 to the feed motor mount plate 13. A hole E provided for the SUS plate 14 is for inserting a screw 15 through. A reference code C denotes a position of a rotary shaft of the motor 66, and a circle D denotes a position of the magnet 12a.

FIGS. 3A and 3B show an embodiment of the Hall element 10: FIG. 3A being an outer shape view of the Hall element 10, and FIG. 3B showing an equivalent circuit. As shown in FIG. 3A, the Hall element 10 comprises two magnetically sensitive poles (H1, H2) arranged in one chip, and the magnetically sensitive poles are manufactured as magnetically sensitive films made of InSb or the like by using a printing technique. The simultaneous formation of the two magnetically sensitive poles in the same chip facilitates control when the magnetically sensitive films are printed on the chip, and enables accurate matching of sensitivities between the two poles. Here, a substrate on which the magnetically sensitive poles are disposed is called a chip, and the chip on which magnetically sensitive poles are disposed is called a Hall element. A chip size L1×L2 is 2 mm×1.25 mm in the case of the embodiment.

As shown in the equivalent circuit of FIG. 3B, power input sections of identical polarities of the magnetically sensitive poles H1, H2 are connected to each other. As shown in FIG. 3A, power input terminals +, −, and output terminals 01+, 01−, 02+, 02−of the magnetically sensitive poles are disposed on a chip side face. In this case, there are no problems even if the power input terminals (+, −) are types to be pulled out for each Hall element. A distance L3 between centers of the magnetically sensitive poles H1, H2 is equivalent to an electric angle 90° when they are combined with the magnet 12a of a radius r. When the radius r is 2 mm, the distance becomes 0.62 mm. In the case of using such a chip of 2 mm×1.25 mm, the distance between the centers of the magnetically sensitive poles H1, H2 can be set in a range of 0.6 mm to 1.4 mm in accordance with the radius r of the magnet. If a photographic printing method is used, the magnetically sensitive poles can be disposed on a chip of a much smaller size.

FIG. 4 shows a B portion of a Hall FPC 11 attached to the feed motor mount plate 13. The Hall FPC is fixed to the motor so that the magnetically sensitive poles H1 and H2 of the Hall element 10 can be arranged in optional positions on a circumference of a diameter 4±0.05 mm (center is a center of the rotary shaft 66b of the motor 66, i.e., a rotational center of the magnetic 12a). A surface of the FPC 11 opposite the side where the Hall element 10 is disposed is stuck to the SUS plate 14. This SUS plate 14 is fixed to the feed motor plate 13 by a screw 15.

Conventionally, two Hall element chips each of which has one magnetically sensitive pole have been arranged on a diameter 4±0.05 mm at an electric angle 90° therebetween. Accordingly, during manufacturing of a Hall FPC unit (finished FPC product to which the Hall element 10, etc., are fixed), and when a motor assembly similar to that shown in FIGS. 1A and 1B is assembled, high positional accuracy is required for both of the two Hall element chips.

Therefore, according to the embodiment, many effects such as those described below can be obtained.

1) Attaching accuracy of the Hall element 10 can be secured only by matching with a predetermined radius of the magnet 12a.

2) The number of components for detecting the rotation of the motor 66 can be reduced.

3) The reduced number of components enables further miniaturization.

4) Yield can be greatly improved in the manufacturing state of the Hall FPC unit.

5) Costs can be reduced.

6) Reliability can be improved.

7) Weight can be reduced.

8) Improved yield enables reductions of fixed and turnover stocks.

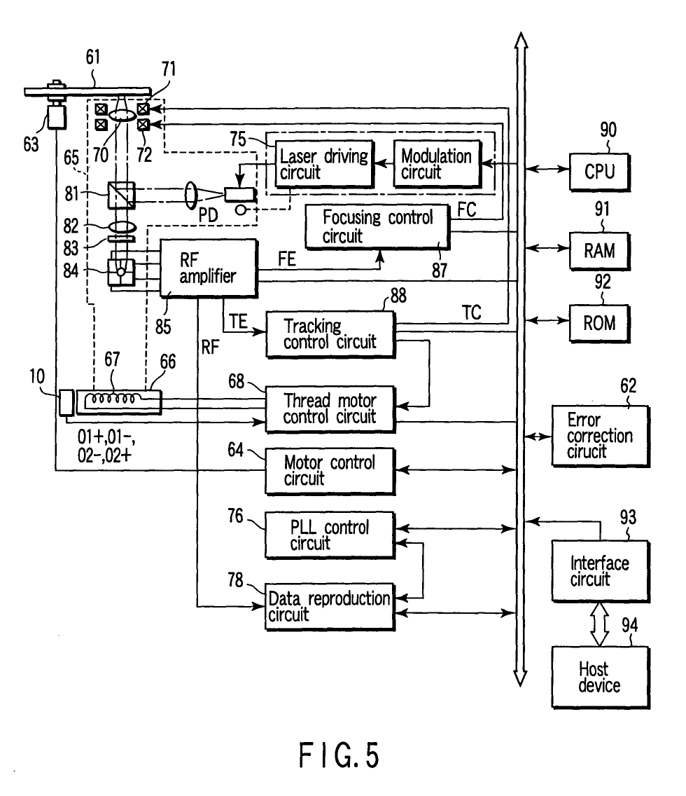

Next, description will be made of an embodiment of an optical disk device which uses the Hall element 10 of the present invention. FIG. 5 is a block diagram showing a constitution of the optical disk device of the embodiment.

An optical disk 61 is a read-only optical disk or an optical disk on which user data can be recorded. The disk 61 is rotary-driven by a spindle motor 63. Recording/reproducing of information on/from the optical disk 61 is carried out by an optical pickup head (PUH hereinafter) 65. The PUH 65 is connected through a gear to a thread motor 66. The thread motor 66 is controlled by a thread motor control circuit 68.

A seek destination address of the PUH 65 is entered from a CPU 90 to the thread motor control circuit 68. Based on this address, the thread motor control circuit 68 controls the thread motor 66. A permanent magnet is fixed inside the thread motor 66, and a driving coil 67 is excited by the thread motor control circuit 68 to move the PUH 65 in a radial direction of the optical disk 61. The Hall element 10 of the present invention is fixed to the thread motor 66 to detect rotation of the thread motor. From Hall element signals 01+, 01−, 02+, 02− generated by the Hall element 10, the thread motor control circuit 68 determines a rotational direction and a rotational speed of the thread motor 66 to control the same.

In the PUH 65, a objective lens 70 is disposed to be supported by a not-shown wire or leaf spring. The objective lens 70 is driven by a driving coil 72 to move in a focusing direction (optical axis direction of the lens), and driven by a driving coil 71 to move in a tracking direction (direction orthogonal to an optical axis of the lens).

A laser driving circuit 75 in a laser control circuit 73 causes a semiconductor laser 79 to emit a laser beam. The laser beam emitted from the semi-conductor laser 79 is radiated through a collimator lens 80, a half prism 81 and the object lens 70 to the optical disk 61. Reflected light from the optical disk 61 is guided through the objective lens 70, the half prism 81, a condenser lens 82 and a cylindrical lens 83 to a photodetector 84.

The photodetector 84 is constituted of, for example 4-division photodetection cells, and a detection signal from each of the divided photodetection cells is output to an RF amplifier 85. The RF amplifier 85 synthesizes the signals from the photodetection cells, and generates a focus error signal FE indicating an error from a just focus, a tracking error signal TE indicating an error between a beam spot center of a laser beam and a track center, and an RF signal which is an all-added signal of the photodetection cell signals.

The focus error signal FE is supplied to a focusing control circuit 87. The focusing control circuit 87 generates a focus control signal FC in accordance with the focus error signal FE. The focus control signal FC is supplied to the driving coil 72 of a focusing direction to carry out focus servo so that the laser beam can be always just focused on a recording film of the optical disk 61.

The tracking error signal TE is supplied to a tracking control circuit 88. The tracking control circuit 88 generates a tracking control signal TC in accordance with the tracking error signal TE. The tracking control signal TC is supplied to the driving coil 72 of a tracking direction to carry out tracking servo so that the laser beam can always trace a track formed on the optical disk 61.

By the focus servo and the tracking servo, a change in a reflected light from a pit or the like formed on the track of the optical disk 61 is reflected in the all-added signal RF of the output signals of the photodetection cells of the photodetector 84. This signal is supplied to a data reproducing circuit 78. The data reproducing circuit 78 reproduces recorded data based on a reproducing clock signal from a PLL circuit 76.

While the objective lens 70 is controlled by the tracking control circuit 88, the thread motor 66, i.e., the PUH 65, is controlled by the thread motor control circuit 68 so that the objective lens 70 can be positioned in the vicinity of a predetermined position in the PUH 65.

The motor control circuit 64, the thread motor control circuit 68, the laser control circuit 73, the PLL circuit 76, the data reproducing circuit 78, the focusing control circuit 87, the tracking control circuit 88, the error correction circuit 62, etc., are controlled by the CPU 90 through a bus 89. The CPU 90 comprehensively controls the recording/reproducing device in accordance with an operation command provided through an interface circuit 93 from a host device 94. Alternatively, the CPU 90 uses a RAM 91 as a work area, and carries out a predetermined operation in accordance with a program recorded in a ROM 92.

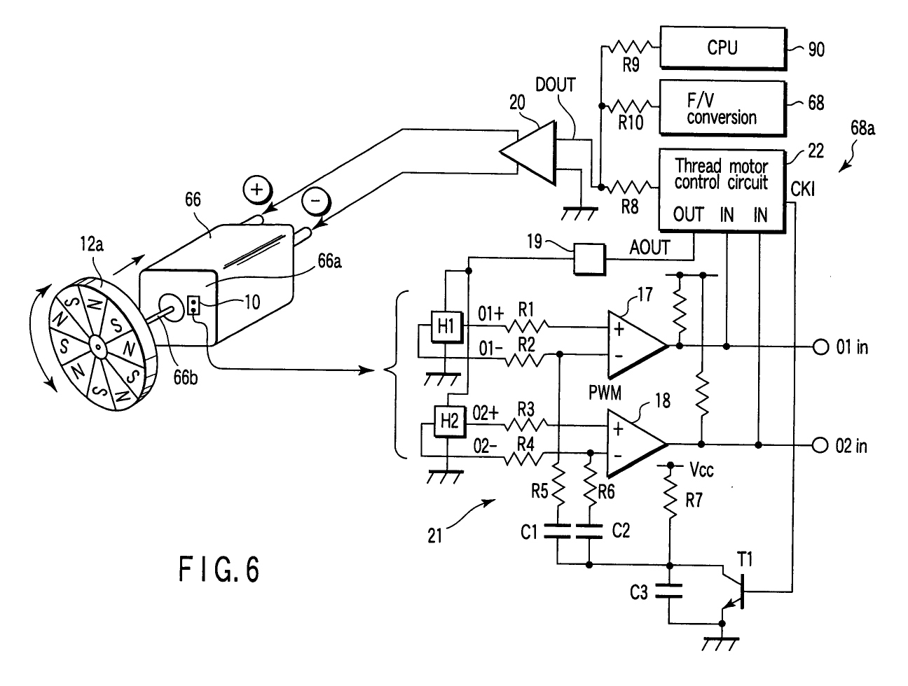

FIG. 6 shows the thread motor 66, the Hall element 10, the magnet 12a, and a processing circuit 68a for processing an output signal of the Hall element 10. The circuit 68a is included in the thread motor control circuit 68.

The Hall element 10 is disposed oppositely to the 10-pole magnetization magnet 12a attached to the rotary shaft 66b of the thread motor 66. The Hall element 10 is disposed on the end surface 66a of the motor 66 through the FPC so that the magnetically sensitive poles H1, H2 can have a predetermined electric angle with respect to the center of the rotary shaft 66b.

The terminal of the thread motor 66 is connected to a driver IC 20 connected to an output terminal of the control circuit 68a. Outputs 01+, 01−, 02+, 02− of the Hall element 10 are supplied through resistors R1 to R4 to comparators 17, 18. Each of the comparators 17, 18 converts a very weak level signal into a rectangular wave of a logic level, and supplies it to an F/V conversion IC 22. Also, the outputs 01−, 02− are supplied through the resistors R2, R4 to a saw-tooth wave generation section 21. The saw-tooth wave generation section 21 comprises resistors R5, R6, R7, capacitors C1, C2, C3, and a transistor T1.

The F/V conversion IC 22 outputs, for example, a clock signal of CK1 of 8 KHz necessary for PWM modulation of a Hall element output. By this clock signal CK1, the transistor T1 is repeatedly turned ON/OFF. When the clock signal CK1 is at an L level, the transistor T1 is turned OFF to apply charge through the resistor R7 to the capacitor C3. When the clock signal CK1 is at an H level, the transistor T1 is turned ON to discharge charge from the capacitor C3. As a result, a saw-tooth wave is generated in a connector of the transistor T1. The generated saw-tooth wave is superimposed through the capacitor C1 and the resistors R5 and R2 on the Hall element output 01−. Also, the saw-tooth wave is superimposed through the capacitor C2 and the resistors R6 and R4 on the Hall element output 02−.

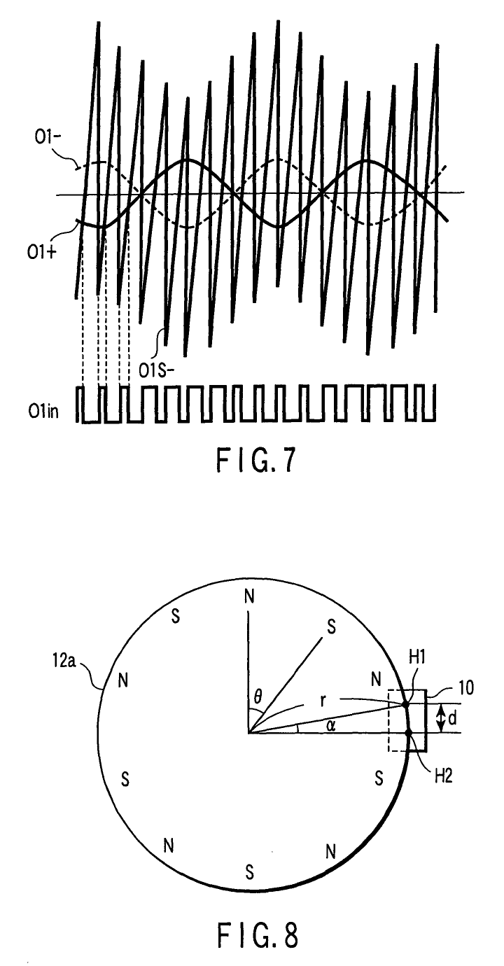

FIG. 7 shows the Hall element output signals 01−, 01+, a signal 01S—on which the saw-tooth wave is superimposed (inversion input of the comparator 17), and a signal 01in output from the comparator 17. In this way, the Hall element outputs 01−, 01+ are subjected to pulse width modulation (PWM). The pulse width-modulated signal 01in is supplied to the F/V conversion IC 22. The comparator 18 is operated similarly to the comparator 17 to supply an output signal 02in to the F/V conversion IC 22.

The F/V conversion IC 22 detects a rotational angle and a rotational direction of the motor 66 from the entered signals 01in, 02in, and outputs a control signal AOUT for optimizing an output level of the Hall element 10, and a control signal DOUT to the thread motor 66. In this example, the F/V conversion IC 22 carries out control to stop the thread motor 66 in a predetermined position. The thread motor control circuit 68 controls an operation/nonoperation of the F/V conversion IC 22. Additionally, the thread motor control circuit 68 outputs a control signal to the driver IC 20 based on the seek command from the CPU 90 and the output signals 01in, 02in of the comparators 17, 18, and controls a seeking operation of the PUH 65 by a signal added through R8, R9, R10.

Next, a relation between the magnet 12a and the Hall element 10 will be described.

According to the embodiment, the magnet 12a is a 10-pole magnetization magnet. Thus, as shown in FIG. 8, an angle θ between straight lines connecting a magnet center (rotational center) to centers of adjacent magnetic poles is 36°. When the magnet 12a is rotated by the angle θ, a phase of a signal output from each magnetically sensitive pole is changed by 180°. A signal (e.g., 01+, 02+) output from the Hall element by the rotation of the magnet 12a must be deviated by 90° in phase according to the embodiment. Thus, an angle α between straight lines connecting the magnet center to centers of the magnetically sensitive poles is 18°. That is, the angle α between the straight lines connecting the centers of the magnetically sensitive poles H1, H2 to the magnet center is ½ of the angle θ between the straight lines connecting the centers of the adjacent magnetically sensitive poles to the magnet center. If a radial position r of each of the magnetically sensitive poles H1, H2 is 2 mm, a distance d between the centers of the magnetically sensitive poles becomes 0.626 mm shown below.

Sin(α/2)×e×2=sin9°×2 mm×2=0.626 mm

In the case of the conventional Hall element where one magnetically sensitive pole is disposed on one chip, shortening of a distance between the magnetically sensitive poles is impossible because of collision between the chips. Thus, conventionally, the Hall element has been laid out at an N times±90° of an electric angle 180°. When the motor assembly similar to that shown in FIGS. 1A and 1B is assembled, high attaching positional accuracy has conventionally been required for the angle α between the straight lines connecting the centers of the magnetically sensitive poles to the magnet center and the radial position of each magnetically sensitive pole. However, according to the embodiment, since it is only necessary to satisfy the accuracy of the radial position of each magnetically sensitive pole, manufacturing of the Hall FPC and assembling of the motor assembly are facilitated.

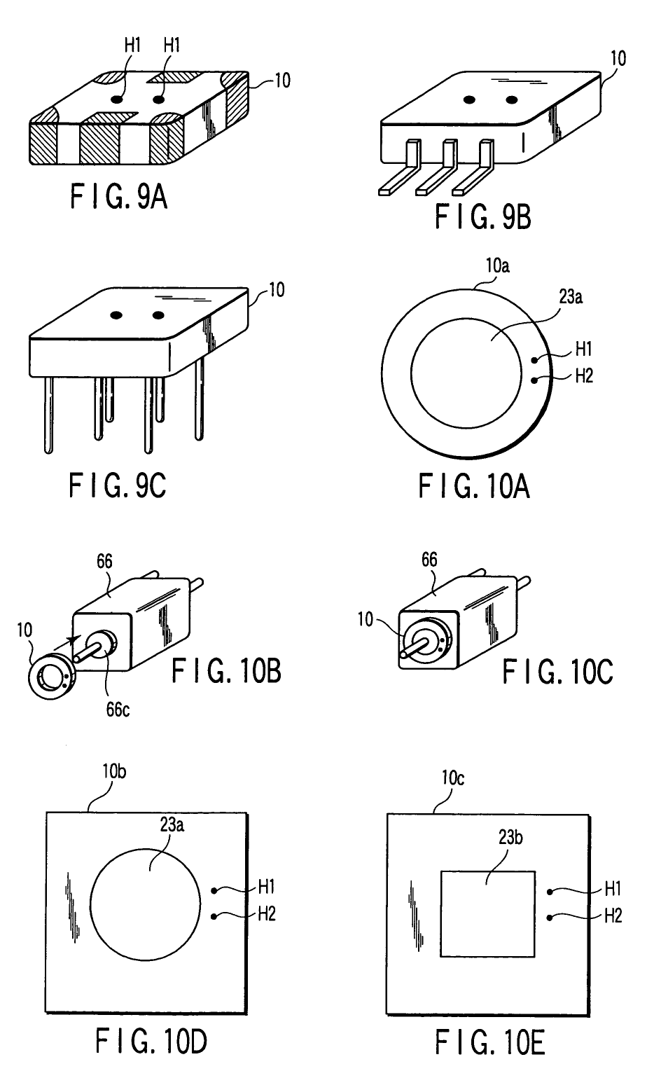

FIGS. 9A to 9C show various forms of the Hall element 10. The chip of the Hall element 10 of the aforementioned embodiment is a surface mounted Hall element having no metal leads as shown in FIG. 9A. However, as other forms, even a metal terminal component of a lead frame type shown in FIG. 9B or a component having a lead shown in FIG. 9C can similarly realize a Hall element which has a plurality of magnetically sensitive poles.

FIGS. 10A to 10E show a Hall element which has an opening provided for a chip and can realize high positional accuracy of the magnetically sensitive poles H1, H2 with respect to the motor rotary shaft more easily when the motor assembly 100 similar to that shown in FIGS. 1A and 1B is assembled.

In a Hall element 10a of FIG. 10A, a chip is formed in a ring shape, and a reference numeral 23a denotes a circular opening. In this case, as shown in FIG. 10B, a doughnut-shaped Hall element receiving section 66c is disposed around the shaft in the motor 66 or the feed motor mount plate 13. The Hall element 10a is first soldered to the FPC, and then fitted to the Hall element receiving section 66c as shown in FIGS. 10B and 10C. Thus, if mechanical accuracy of the Hall element 10a and the Hall element receiving section 66 is a predetermined value or higher, almost no positional accuracy is required when the Hall element 10a is soldered to the Hall FPC and attached to the motor 66.

FIG. 10D shows a Hall element 10b having a circular opening 23a, where a chip is formed in a rectangular and large outer shape to be easily fixed to the FPC. FIG. 10E shows a Hall element 10c where a rectangular opening 23b is provided for a rectangular chip to secure absolute positional accuracy of magnetically sensitive poles. In this case, a rectangular Hall element receiving section is provided for the motor 66 side, and the rectangular opening 23b is fitted to the Hall element receiving section.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. A Hall element comprising:
a chip;
two magnetically sensitive poles disposed on the chip, each of which has positive and negative side power input sections and two signal output sections;
a positive side electrode connected to the positive side power input sections of both magnetically sensitive poles and disposed on the chip;
a negative side electrode connected to the negative side power input sections of both magnetically sensitive poles and disposed on the chip; and
signal output electrodes which connected to the signal output sections and disposed on the chip.

2. A Hall element according to claim 1, wherein a distance between center points of the magnetically sensitive poles is 1.4 mm or lower.

3. A Hall element according to claim 1, wherein the chip has an opening through which a motor rotary shaft passes.

4. A motor assembly comprising:
a motor having a rotary shaft;
a magnet fixed to the rotary shaft and having a plurality of magnetic poles magnetized on the magnet; and
a Hall element fixed to the motor and sensing a change in a magnetic field following rotation of the magnet, the hall element comprising, a chip;
two magnetically sensitive poles disposed on the chip, each of which has positive and negative side power input sections and two signal output sections;
a positive side electrode connected to the positive side power input sections of both magnetically sensitive poles and disposed on the chip;
a negative side electrode connected to the negative side power input sections of both magnetically sensitive poles and disposed on the chip; and
signal output electrodes which connected to the signal output sections and disposed on the chip.

5. A motor assembly according to claim 4, wherein an angle between straight lines connecting centers of the magnetically sensitive poles to a center of the rotary shaft is ½ of an angle between straight lines connecting centers of adjacent magnetic poles of the magnet to the center of the rotary shaft.

6. A motor assembly according to claim 5, wherein the chip has an opening through which the rotary shaft of the motor passes.

7. An optical disk device comprising:
an optical pickup irradiating an optical disk with an optical beam so as to reproduce information;
a motor having a rotary shaft and moving the optical pickup in a radial direction of the optical disk;
a magnet fixed to a rotary shaft having a plurality of magnetic poles magnetized on the magnet; and
a Hall element fixed to the motor and comprising, a chip, first and second magnetically sensitive poles formed in the chip and sensing a change in a magnetic field following rotation of the magnet, and, a output electrode outputting a signal from the first and the second magnetically sensitive poles; and
a motor control circuit controlling the motor to move the optical pickup according to a output signal of the output electrode.

8. An optical disk device according to claim 7, wherein an angle between straight lines connecting centers of the magnetically sensitive poles to a center of the rotary shaft is ½ of an angle between straight lines connecting centers of adjacent magnetic poles of the magnet to the center of the rotary shaft.

9. An optical disk device according to claim 7, wherein an opening through which the rotary shaft of the motor passes is provided for the chip.
